(19) United States
(12) Patent Application Publication
(10) Pub. No.: US 2011/0128388 A1
(43) Pub. Date: Jun. 2, 2011

(54) CAMERA CALIBRATION SYSTEM AND COORDINATE DATA GENERATION SYSTEM AND METHOD THEREOF

(75) Inventors: Hung-I Pai, Taipei County (TW); Shang-Chih Hung, Taichung City (TW); Chii-Yah Yuan, Hsinchu City (TW); Yi-Yuan Chen, Taoyuan County (TW); Kung-Ming Lan, Yilan County (TW)

(73) Assignee: INDUSTRIAL TECHNOLOGY RESEARCH INSTITUTE, Hsinchu (TW)

(21) Appl. No.: 12/754,617

(22) Filed: Apr. 6, 2010

(30) Foreign Application Priority Data
Dec. 1, 2009 (TW) 98141037

(51) Int. Cl. H04N 17/00

(52) U.S. Cl. 348/187; 348/E17.001

(57) ABSTRACT

A camera calibration system including a coordinate data generation device and a coordinate data recognition device is provided. The coordinate data generation device generates a plurality of map coordinate data corresponding to a plurality of real positions in a real scene. The coordinate data recognition device receives an image plane of the real scene from a camera to be calibrated and receives the map coordinate data from the coordinate data generation device. Besides, the coordinate data recognition device recognizes image positions corresponding to the real positions in the image plane and calculates image coordinate data corresponding to the image positions. Moreover, the coordinate data recognition device calculates a coordinate transform matrix corresponding to the camera according to the image coordinate data and the map coordinate data. Thereby, the camera calibration system can finish the calibration of the camera quickly.

### CROSS-REFERENCE TO RELATED APPLICATION

This application claims the priority benefit of Taiwan application serial no. 98141037, filed on Dec. 1, 2009. The entirety of the above-mentioned patent application is hereby incorporated by reference herein and made a part of specification.

### BACKGROUND

1. Field

The disclosure relates to a camera calibration method, and a coordinate data generation method.

2. Description of Related Art

Along with the development of imaging technology, video surveillance systems have been broadly applied in positioning monitored people. In an existing surveillance system, an operator determines the position of a monitored person by directly looking at the surveillance image. However, since the direction and size of the surveillance image are restricted by the deployed position of the camera, the operator cannot instantly determine the position and movement of the monitored person. Especially when the monitored person moves out of the monitored area of a single camera and is about to cross over the monitored areas of different cameras, it is difficult for the operator to determine in the surveillance image of which camera the monitored person will appear again. In order to resolve this problem, the position of a moving object in a surveillance image is marked on a map so that a complete view of the monitored area can be provided to the operator.

In order to obtain the position of a moving object captured by a surveillance camera on the map, conventionally, every surveillance camera is calibrated to obtain the correlation between an image plane captured by the camera and a ground plane of the real scene. The theory of the conventional technique will be explained herein.

A real moving object forms a ground point (GP) on the ground plane, and the GP is corresponding to a projection point on the image plane captured by the camera. Regarding a specific camera, one coordinate transform matrix exists between the coordinate of the projection point and the coordinate of the GP. Regarding different cameras, each camera is corresponding to one coordinate transform matrix. Namely, the image coordinate of a moving object in a camera can be converted into a unique coordinate on the ground plane through the coordinate transform matrix. Once the coordinate on the ground plane is obtained, the position of the moving object can be easily marked on the map based on the scale and direction information of the map and the real scene.

A homograph matrix is usually used as the coordinate transform matrix for carrying out the coordinate conversion mentioned above. In this technique, the coordinates of at least four sets of corresponding points are determined on two object planes, and a coordinate transform matrix H is obtained by resolving simultaneous equations. When the present technique is applied to the calibration of a camera, the two object planes refer to the image plane of the camera and the real ground plane. The existing technique for obtaining the coordinate transform matrix between the image plane of the camera and the real ground plane is to manually select four sets of corresponding feature points on the image plane and the ground plane that are easy to identify, respectively calculate the coordinates of the feature points on the image plane and the ground plane, and then obtain the homograph matrix corresponding to the camera.

However, in this technique, it is not easy to find the feature points that are easy to be identified on both the image plane and the ground plane. Thus, the calibration of the camera relies greatly on the experience of the operator. In addition, the coordinates of the feature points on the ground plane need to be manually measured. Since the positions of the feature points on the ground plane may be difficult to measure due to restrictions of the terrain and the environment (i.e., the feature points and a reference point do not fall on a straight line), an indirect measuring technique may be adopted. As to a large surveillance system, there may be hundreds of surveillance cameras and accordingly it may be very time-consuming and labor-consuming to calibrate the cameras in such a large-scaled system. Thereby, how to automatically calibrate a camera has become one of the major subjects in the industry.

### SUMMARY

Accordingly, the disclosure is directed to a camera calibration system that can automatically generate a coordinate transform matrix between the image coordinate data of a camera and the map coordinate data of a real scene so as to calibrate the camera.

The disclosure is directed to a camera calibration method that can automatically generate a coordinate transform matrix between the image coordinate data of a camera and the map coordinate data of a real scene so as to calibrate the camera.

The disclosure is directed to a coordinate data generation system that can automatically generate map coordinate data corresponding to real positions.

The disclosure is directed to a coordinate data generation method that can automatically generate map coordinate data corresponding to real positions.

According to an exemplary embodiment of the disclosure, a camera calibration system including at least one coordinate data generation device and a coordinate data recognition device is provided. The coordinate data generation device is disposed in a real scene and respectively generates a plurality of map coordinate data corresponding to a plurality of real positions on a ground plane of the real scene according to a map coordinate system. The coordinate data recognition device is electrically connected to a camera to be calibrated. The coordinate data recognition device receives an image plane from the camera and receives the map coordinate data respectively from the coordinate data generation device. Besides, the coordinate data recognition device respectively recognizes an image position corresponding to each of the real positions in the image plane and calculates an image coordinate data corresponding to each of the image positions according to an image coordinate system on the image plane. Moreover, the coordinate data recognition device calculates a coordinate transform matrix corresponding to the camera according to the image coordinate data and the map coordinate data.

According to an exemplary embodiment of the disclosure, a camera calibration method is provided. The camera calibration method includes disposing at least one coordinate data generation device in a real scene and obtaining an image plane corresponding to the real scene by using a camera to be calibrated. The camera calibration method also includes automatically generating a plurality of map coordinate data corresponding to a plurality of different real positions on a ground plane of the real scene according to a map coordinate system and transmitting the map coordinate data corresponding to the real positions by using the coordinate data generation device. The camera calibration method further includes recognizing an image position corresponding to each of the real positions in the image plane, calculating an image coordinate data corresponding to each of the image positions according to an image coordinate system of the image plane, receiving the map coordinate data corresponding to the real positions, and calculating a coordinate transform matrix corresponding to the camera according to the image coordinate data and the map coordinate data.

According to an exemplary embodiment of the disclosure, a coordinate data generation system including a physical information capturing unit and a controller is provided. The physical information capturing unit captures physical information between a reference point in a real scene and a real position in the real scene. The controller is electrically connected to the physical information capturing unit and generates a map coordinate data corresponding to the real position in a map coordinate system according to the physical information between the reference point and the real position.

According to an exemplary embodiment of the disclosure, a coordinate data generation method is provided. The coordinate data generation method includes disposing a coordinate data generation device in a real scene. The coordinate data generation method also includes automatically capturing physical information between a reference point in the real scene and a real position in the real scene and generating a map coordinate data corresponding to the real position in a map coordinate system according to the physical information by using the coordinate data generation device.

As described above, in the disclosure, a coordinate transform matrix between the image coordinate data of a camera and the map coordinate data of a real scene can be quickly generated so as to calibrate the camera.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a camera calibration system according to a first exemplary embodiment of the disclosure.

FIG. 2 illustrates the conversion between an image plane and a ground plane in a real scene according to the first exemplary embodiment of the disclosure.

FIG. 3 is a schematic block diagram of a coordinate data generation device according to the first exemplary embodiment of the disclosure.

FIG. 4 illustrates how a coordinate data generation device measures the map coordinate data corresponding to real positions according to the first exemplary embodiment of the disclosure.

FIG. 5 is a flowchart of a coordinate data generation method according to the first exemplary embodiment of the disclosure.

FIG. 6 is a schematic block diagram of a coordinate data recognition device according to the first exemplary embodiment of the disclosure.

FIG. 7 illustrates how a coordinate data recognition device calculates the image coordinate data corresponding to image positions according to the first exemplary embodiment of the disclosure.

FIG. 8 is a flowchart of a camera calibration method according to the first exemplary embodiment of the disclosure.

FIG. 9 is a schematic block diagram of a camera calibration system according to a second exemplary embodiment of the disclosure.

FIG. 10 is a schematic block diagram of a coordinate data generation device according to the second exemplary embodiment of the disclosure.

FIG. 11 is a schematic block diagram of a feature point positioning unit according to the second exemplary embodiment of the disclosure.

FIG. 12 illustrates how to measure the map coordinate data corresponding to a real position according to the second exemplary embodiment of the disclosure.

FIG. 13 is a flowchart of a coordinate data generation method according to the second exemplary embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Exemplary Embodiment

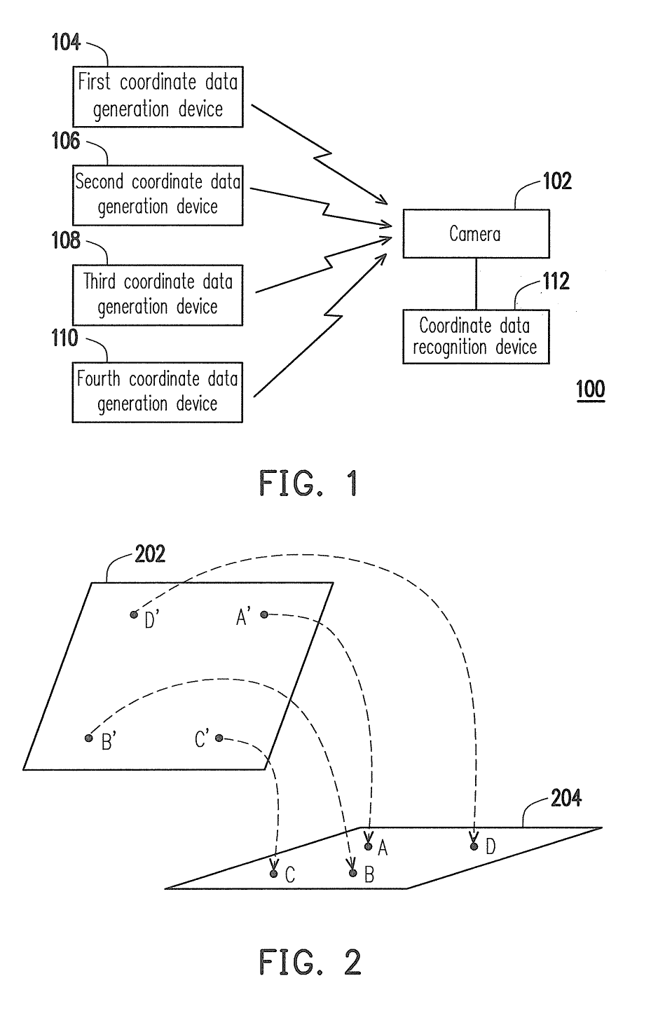

FIG. 1 is a schematic block diagram of a camera calibration system according to the first exemplary embodiment of the disclosure, and FIG. 2 illustrates the conversion between an image plane and a ground plane in a real scene according to the first exemplary embodiment of the disclosure.

Referring to FIG. 1, the camera calibration system 100 includes a first coordinate data generation device 104, a second coordinate data generation device 106, a third coordinate data generation device 108, a fourth coordinate data generation device 110, and a coordinate data recognition device 112. The camera calibration system 100 is configured to calibrate a camera 102, wherein the camera 102 is used for capturing an image plane 202 of a real scene to be monitored.

The first coordinate data generation device 104, the second coordinate data generation device 106, the third coordinate data generation device 108, and the fourth coordinate data generation device 110 generate map coordinate data corresponding to real positions in the real scene. To be specific, the first coordinate data generation device 104, the second coordinate data generation device 106, the third coordinate data generation device 108, and the fourth coordinate data generation device 110 are respectively placed at four different real positions A, B, C, and D on a ground plane 204 of the real scene (as shown in FIG. 2), and the first coordinate data generation device 104, the second coordinate data generation device 106, the third coordinate data generation device 108, and the fourth coordinate data generation device 110 respectively generate the map coordinate data corresponding to their own positions in the map coordinate system on the ground plane 204 of the real scene. For example, the map coordinate system on the ground plane 204 of the real scene is a longitude/latitude coordinate system, a 2-degree transverse Mercator (TM2) coordinate system, or a coordinate system defined by a user.

It has to be understood that in the present exemplary embodiment, the camera calibration system 100 includes four coordinate data generation devices (i.e., the first coordinate data generation device 104, the second coordinate data generation device 106, the third coordinate data generation device 108, and the fourth coordinate data generation device 110) for generating the map coordinate data corresponding to four different real positions in the real scene. However, the disclosure is not limited thereto, and in another exemplary embodiment of the disclosure, only one coordinate data generation device is disposed, and the map coordinate data corresponding to the four different real positions in the real scene is generated by manually or automatically moving the coordinate data generation device to the four real positions. In addition, in yet another exemplary embodiment of the disclosure, more coordinate data generation devices are disposed to generate the map coordinate data corresponding to more real positions.

It should be mentioned that in the present exemplary embodiment, the first coordinate data generation device 104, the second coordinate data generation device 106, the third coordinate data generation device 108, and the fourth coordinate data generation device 110 respectively emit a light source and transmit the map coordinate data through the emitted pattern of the light source.

The coordinate data recognition device 112 is electrically connected to the camera 102. The coordinate data recognition device 112 receives the image plane 202 of the real scene captured by the camera 102 from the camera 102. In particular, the coordinate data recognition device 112 recognizes and analyzes the image plane 202 of the real scene captured by the camera 102 to identify the light source emitted by each coordinate data generation device, obtains image coordinate data corresponding to each coordinate data generation device in an image coordinate system on the image plane 202 according to the light source identified above, receives the map coordinate data from each coordinate data generation device, and calculates a coordinate transform matrix corresponding to the camera 102 according to the image coordinate data corresponding to each coordinate data generation device in the image coordinate system on the image plane 202 and the map coordinate data received from each coordinate data generation device in the map coordinate system of the real scene.

To be specific, the coordinate data recognition device 112 recognizes and analyzes the light sources in the image plane 202 of the real scene captured by the camera 102 to identify the image position A′ of the first coordinate data generation device 104, the image position B′ of the second coordinate data generation device 106, the image position C′ of the third coordinate data generation device 108, and the image position D′ of the fourth coordinate data generation device 110 on the image plane 202 and calculates the image coordinate data corresponding to the image positions A′, B′, C′, and D′. Besides, the coordinate data recognition device 112 respectively receives the map coordinate data corresponding to the real position A, B, C, and D from the light sources emitted by the first coordinate data generation device 104, the second coordinate data generation device 106, the third coordinate data generation device 108, and the fourth coordinate data generation device 110. After that, the coordinate data recognition device 112 generates the coordinate transform matrix corresponding to the camera 102 according to the image coordinate data corresponding to the image positions A′, B′, C′, and D′ and the map coordinate data corresponding to the real positions A, B, C, and D, so as to complete the calibration of the camera 102. Herein the coordinate transform matrix calculated by the coordinate data recognition device 112 may be a homograph matrix. Below, the operations of the coordinate data generation devices and the coordinate data recognition device will be described in detail with reference to accompanying drawings.

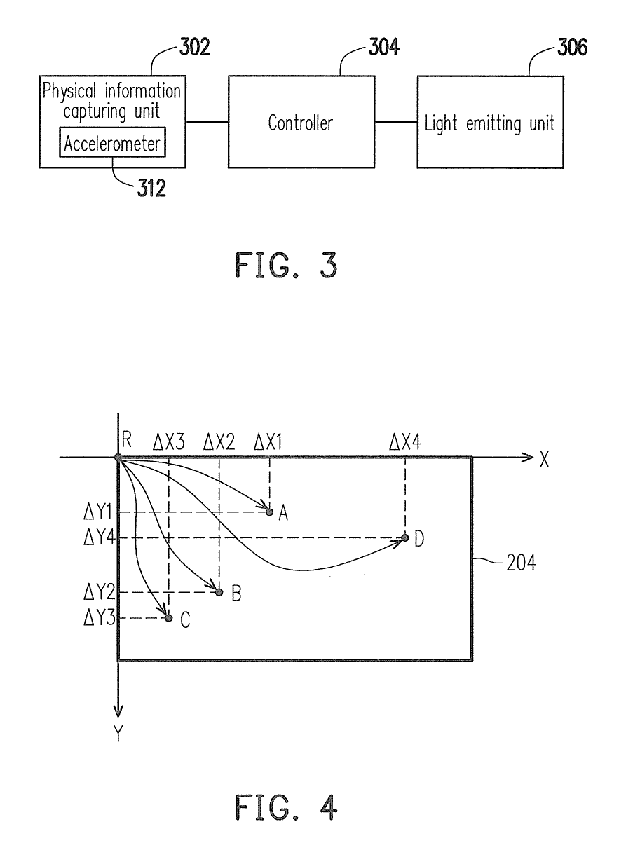

FIG. 3 is a schematic block diagram of a coordinate data generation device according to the first exemplary embodiment of the disclosure, and FIG. 4 illustrates how a coordinate data generation device measures the map coordinate data corresponding to real positions according to the first exemplary embodiment of the disclosure.

The first coordinate data generation device 104, the second coordinate data generation device 106, the third coordinate data generation device 108, and the fourth coordinate data generation device 110 have the same structure and function. Below, the first coordinate data generation device 104 will be described as an example.

Referring to FIG. 3, the first coordinate data generation device 104 includes a physical information capturing unit 302, a controller 304, and a light emitting unit 306.

The physical information capturing unit 302 captures physical information between a reference point and a real position (for example, the real position A) on the ground plane 204 of the real scene. In the present exemplary embodiment, the physical information capturing unit 302 includes an accelerometer 312. To be specific, when a user is about to calibrate the camera 102 and accordingly disposes the first coordinate data generation device 104 at the real position A on the ground plane 204 of the real scene, the user needs to reset (i.e., set to zero) the physical information capturing unit 302 and moves the first coordinate data generation device 104 from the reference point R to the real position A. Then, the physical information capturing unit 302 captures the acceleration of moving the first coordinate data generation device 104 from the reference point R to the real position A.

The controller 304 is electrically connected to the physical information capturing unit 302. When the physical information capturing unit 302 captures the acceleration of moving the first coordinate data generation device 104 from the reference point R to the real position A, the controller 304 calculates the displacements between the real position A and the reference point R on axes X and Y according to the acceleration and generates the map coordinate data corresponding to the real position A according to the displacements. For example, the controller 304 performs two integrations (i.e., Newton's Second Laws of Motion) on the acceleration of moving the first coordinate data generation device 104 from the reference point R to the real position A, so as to obtain the displacements of the real position A relative to the reference point R (for example, the displacement ΔX1 on axis X and the displacement ΔY1 on axis Y, as shown in FIG. 4), and generates the map coordinate data corresponding to the real position A according to the map coordinate data corresponding to the reference point R in the map coordinate system.

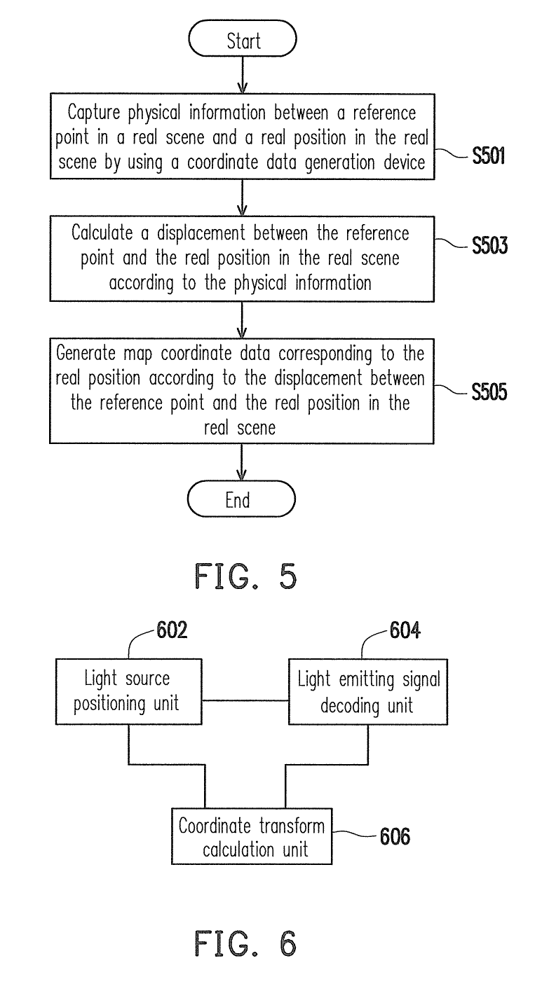

FIG. 5 is a flowchart of a coordinate data generation method according to the first exemplary embodiment of the disclosure.

Referring to FIG. 5, first, in step S501, physical information between a reference point in a real scene and a real position in the real scene is captured by using a coordinate data generation device. For example, in the present exemplary embodiment, the coordinate data generation device 104 measures the acceleration for moving from a reference point R to a real position A in the real scene. Then, in step S503, the displacement between the reference point and the real position in the real scene is calculated according to the physical information. Finally, in step S505, the map coordinate data corresponding to the real position is generated according to the displacement between the reference point and the real position in the real scene.

Besides generating the map coordinate data, the controller 304 also encodes the map coordinate data so that the map coordinate data can be transmitted by the light emitting unit 306.

The light emitting unit 306 is electrically connected to the controller 304, and generates a light source and transmits the map coordinate data encoded by the controller 304 through the light source. To be specific, the controller 304 encodes the map coordinate data into an optical signal. For example, the controller 304 indicates the value of the map coordinate data corresponding to the real position A with different light flashing frequency, and the light emitting unit 306 generates the light source according to the light flashing frequency adopted by the controller 304 so as to transmit the map coordinate data corresponding to the real position A. Namely, the light emitting unit 306 transmits different map coordinate data generated by the controller 304 through different pattern of the light source. Herein the light emitting unit 306 may transmit the optical signal with a single light source or with multiple light sources.

The map coordinate data corresponding to the real positions B, C, and D is generated and transmitted by using the second coordinate data generation device 106, the third coordinate data generation device 108, and the fourth coordinate data generation device 110 through the same method described above therefore will not be described herein.

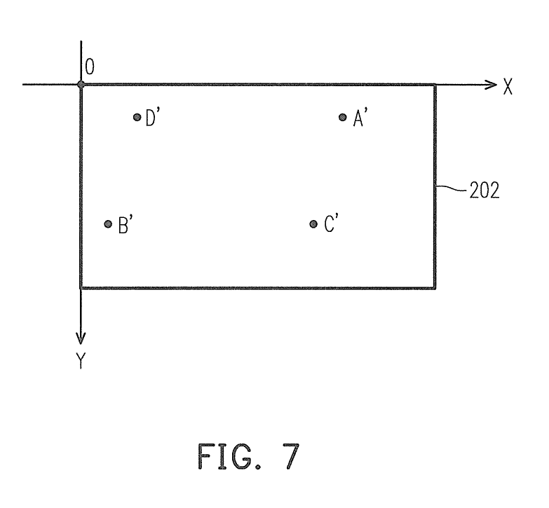

FIG. 6 is a schematic block diagram of a coordinate data recognition device according to the first exemplary embodiment of the disclosure, and FIG. 7 illustrates how a coordinate data recognition device calculates the image coordinate data corresponding to image positions according to the first exemplary embodiment of the disclosure.

Referring to FIG. 6, the coordinate data recognition device 112 includes a light source positioning unit 602, a light emitting signal decoding unit 604, and a coordinate transform calculation unit 606.

The light source positioning unit 602 recognizes and analyzes the image plane 202 of the real scene captured by the camera 102 so as to identify the light sources emitted by the light emitting units of the first coordinate data generation device 104, the second coordinate data generation device 106, the third coordinate data generation device 108, and the fourth coordinate data generation device 110 and obtain the image coordinate data corresponding to the first coordinate data generation device 104, the second coordinate data generation device 106, the third coordinate data generation device 108, and the fourth coordinate data generation device 110 (i.e., the image positions A′, B′, C′, and D′) in the image coordinate system (as indicated by the axes X and Y in FIG. 7) of the image plane 202.

Taking the first coordinate data generation device 104 as an example, the light source positioning unit 602 recognizes the image of the light source emitted by the first coordinate data generation device 104 in the image plane 202 of the real scene captured by the camera 102 and calculates the image coordinate data corresponding to the position (i.e., the image position A′) of the light source in the image coordinate system of the image plane 202 according to the image origin O. As shown in FIG. 7, the light source positioning unit 602 defines the image coordinate system according to the pixels in the image plane 202 and calculates the displacements of the image positions A′, B′, C′, and D′ relative to the image origin O in the image plane 202 as the image coordinate data.

The light emitting signal decoding unit 604 is electrically connected to the light source positioning unit 602. The light emitting signal decoding unit 604 respectively decodes the patterns of the light sources emitted by the light emitting units of the first coordinate data generation device 104, the second coordinate data generation device 106, the third coordinate data generation device 108, and the fourth coordinate data generation device 110 to obtain the map coordinate data corresponding to the real positions A, B, C, and D. Namely, the light emitting signal decoding unit 604 identifies the pattern of the light source emitted by the light emitting unit of a coordinate data generation device and decodes the map coordinate data encoded by the controller of the coordinate data generation device.

The coordinate transform calculation unit 606 is electrically connected to the light source positioning unit 602 and the light emitting signal decoding unit 604. The coordinate transform calculation unit 606 calculates a coordinate transform matrix corresponding to the camera 102 according to the image coordinate data corresponding to the image positions A′, B′, C′, and D′ received from the light source positioning unit 602 and the map coordinate data corresponding to the real position A, B, C, and D received from the light emitting signal decoding unit 604.

In the present exemplary embodiment, the light source positioning unit 602, the light emitting signal decoding unit 604, and the coordinate transform calculation unit 606 are implemented as hardware forms. However, the disclosure is not limited thereto. For example, the coordinate data recognition device 112 is a personal computer, and the light source positioning unit 602, the light emitting signal decoding unit 604, and the coordinate transform calculation unit 606 are disposed in the coordinate data recognition device 112 as software forms.

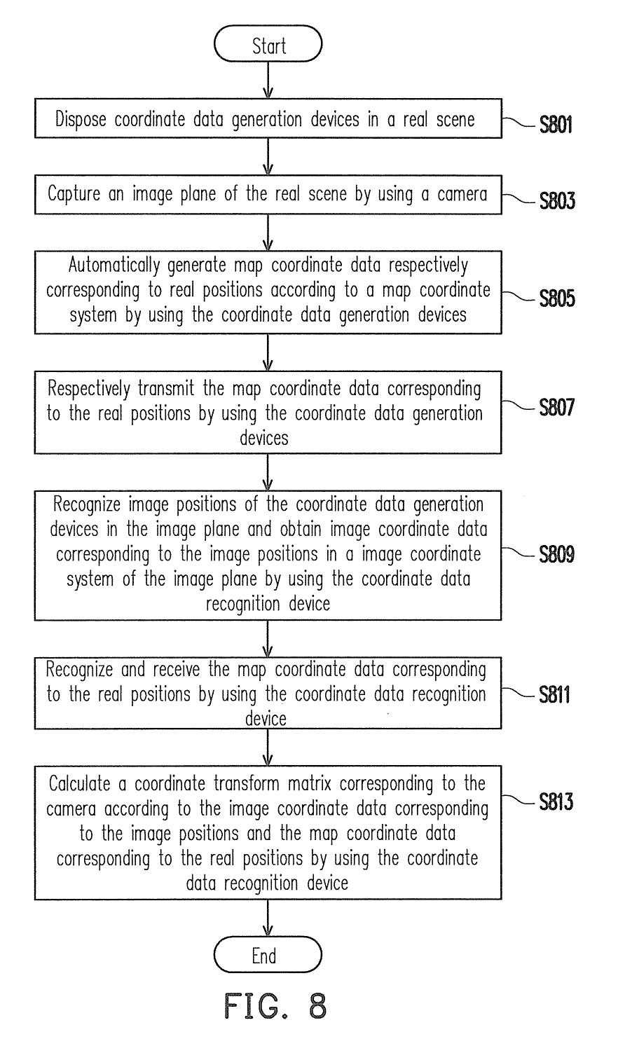

FIG. 8 is a flowchart of a camera calibration method according to the first exemplary embodiment of the disclosure.

Referring to FIG. 8, first, in step S801, the first coordinate data generation device 104, the second coordinate data generation device 106, the third coordinate data generation device 108, and the fourth coordinate data generation device 110 are disposed in a real scene. Then, in step S803, an image plane 202 of the real scene is captured by the camera 102.

In step S805, map coordinate data respectively corresponding to the real positions A, B, C, and D is automatically generated according to a map coordinate system by the first coordinate data generation device 104, the second coordinate data generation device 106, the third coordinate data generation device 108, and the fourth coordinate data generation device 110.

Next, in step S807, the map coordinate data corresponding to the real positions A, B, C, and D is respectively transmitted by the first coordinate data generation device 104, the second coordinate data generation device 106, the third coordinate data generation device 108, and the fourth coordinate data generation device 110. To be specific, the first coordinate data generation device 104, the second coordinate data generation device 106, the third coordinate data generation device 108, and the fourth coordinate data generation device 110 encode the map coordinate data and generate light sources according to the encoded map coordinate data, so as to transmit the map coordinate data corresponding to the real positions A, B, C, and D through the patterns of the light sources.

After that, in step S809, the image positions A′, B′, C′, and D′ of the first coordinate data generation device 104, the second coordinate data generation device 106, the third coordinate data generation device 108, and the fourth coordinate data generation device 110 in the image plane 202 are recognized and the image coordinate data corresponding to the image positions A′, B′, C′, and D′ in a image coordinate system of the image plane 202 is obtained by the coordinate data recognition device 112. To be specific, the coordinate data recognition device 112 recognizes the light sources generated by the first coordinate data generation device 104, the second coordinate data generation device 106, the third coordinate data generation device 108, and the fourth coordinate data generation device 110 in the image plane 202 captured by the camera 102 and calculates the image coordinate data corresponding to the image positions A′, B′, C′, and D′ according to the positions of the light sources.

In step S811, the map coordinate data corresponding to the real positions A, B, C, and D is recognized and received by the coordinate data recognition device 112. For example, the coordinate data recognition device 112 recognizes the light sources in the image plane 202 captured by the camera 102 and decodes the optical signals transmitted by the light sources to obtain the map coordinate data corresponding to the real positions A, B, C, and D.

Finally, in step S813, a coordinate transform matrix corresponding to the camera 102 is calculated according to the image coordinate data corresponding to the image positions A′, B′, C′, and D′ and the map coordinate data corresponding to the real positions A, B, C, and D by the coordinate data recognition device 112. By now, the calibration of the camera 102 is completed.

### Second Exemplary Embodiment

In the camera calibration system of the first exemplary embodiment, a coordinate data generation device calculates the map coordinate data corresponding to a real position by measuring the acceleration of moving from a reference point to the real position. While in the camera calibration system of the second exemplary embodiment, a coordinate data generation device measures the map coordinate data corresponding to a real position through a laser. Below, the difference between the first exemplary embodiment and the second exemplary embodiment will be described.

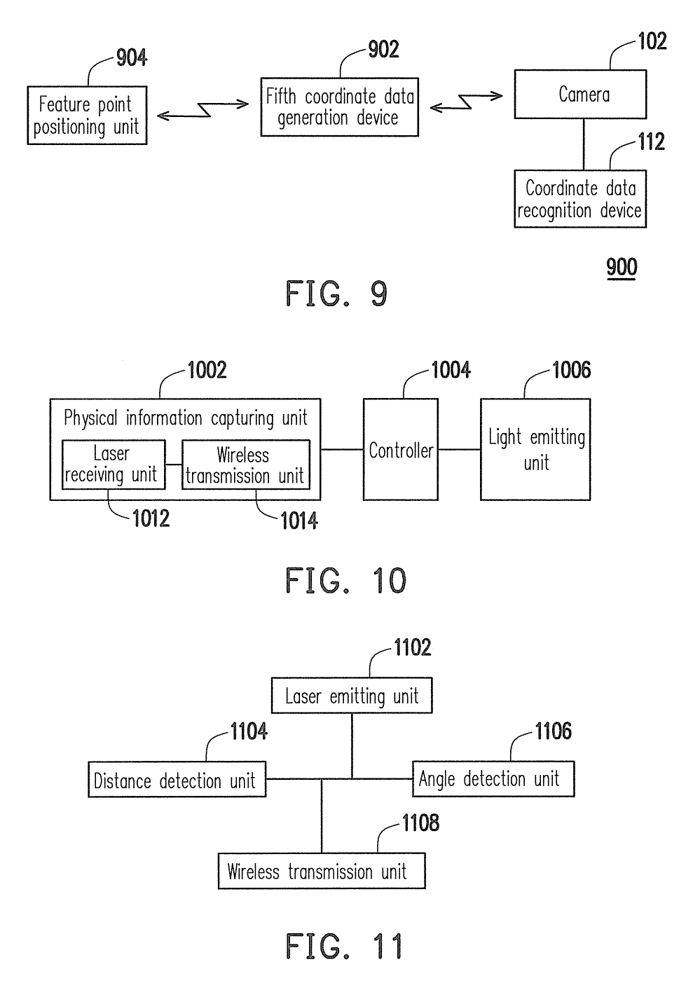

FIG. 9 is a schematic block diagram of a camera calibration system according to the second exemplary embodiment of the disclosure.

Referring to FIG. 9, the camera calibration system 900 includes a fifth coordinate data generation device 902, a feature point positioning unit 904, and a coordinate data recognition device 112. The camera calibration system 900 is configured to calibrate the camera 102. The coordinate data recognition device 112 has the same function and structure as described above therefore will not be described herein.

The feature point positioning unit 904 is disposed on a reference point R in the real scene and emits a laser to measure a relative distance and a relative angle of the fifth coordinate data generation device 902. The fifth coordinate data generation device 902 receives the relative distance and the relative angle from the feature point positioning unit 904 and calculates the corresponding map coordinate data.

FIG. 10 is a schematic block diagram of a coordinate data generation device according to the second exemplary embodiment of the disclosure.

Referring to FIG. 10, the fifth coordinate data generation device 902 includes physical information capturing unit 1002, a controller 1004, and a light emitting unit 1006.

The physical information capturing unit 1002 includes a laser receiving unit 1012 and a wireless transmission unit 1014. The laser receiving unit 1012 receives a laser emitted by a feature point positioning unit 904. The wireless transmission unit 1014 transmits an acknowledgement message and receives a relative distance and a relative angle from the feature point positioning unit 904.

The controller 1004 is electrically connected to the physical information capturing unit 1002. When the physical information capturing unit 1002 captures the relative distance and the relative angle transmitted by the feature point positioning unit 904, the controller 1004 calculates the displacement between a real position and the reference point R according to the relative distance and the relative angle and generates the map coordinate data corresponding to the real position according to the displacement. Besides, the controller 1004 encodes the map coordinate data so that the map coordinate data can be transmitted by the light emitting unit 1006.

FIG. 11 is a schematic block diagram of a feature point positioning unit according to the second exemplary embodiment of the disclosure.

Referring to FIG. 11, the feature point positioning unit 904 includes a laser emitting unit 1102, a distance detection unit 1104, an angle detection unit 1106, and a wireless transmission unit 1108.

The laser emitting unit 1102 rotates the laser for 360° and then emits the laser. The distance detection unit 1104 detects the relative distance between the feature point positioning unit 904 and the fifth coordinate data generation device 902. The angle detection unit 1106 detects the relative angle between the feature point positioning unit 904 and the fifth coordinate data generation device 902. The wireless transmission unit 1108 transmits the relative distance and the relative angle between the feature point positioning unit 904 and the fifth coordinate data generation device 902.

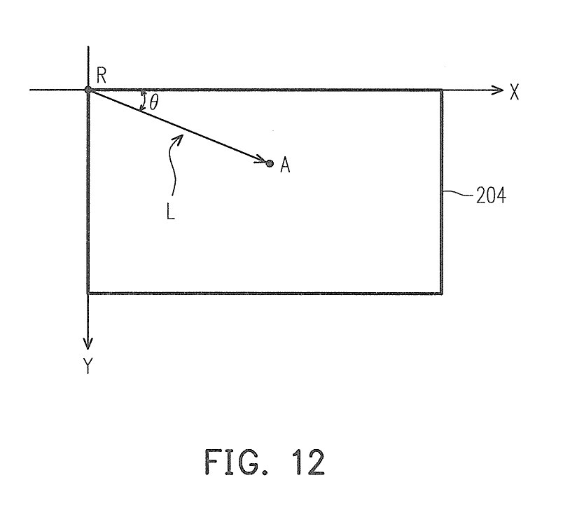

FIG. 12 illustrates how to measure the map coordinate data corresponding to a real position according to the second exemplary embodiment of the disclosure.

Referring to FIG. 12, when the map coordinate data corresponding to a real position A is to be generated, the fifth coordinate data generation device 902 is placed on the real position A in the real scene, and the laser emitting unit 1102 of the feature point positioning unit 904 disposed on the reference point R in the real scene starts to rotate for 360° and continuously emits laser. When the laser receiving unit 1012 of the fifth coordinate data generation device 902 receives the laser emitted by the laser emitting unit 1102, the wireless transmission unit 1014 of the fifth coordinate data generation device 902 sends an acknowledgement message to the wireless transmission unit 1108 of the feature point positioning unit 904. Herein the laser emitting unit 1102 instantly stops rotating, and the distance detection unit 1104 measures the relative distance L between the feature point positioning unit 904 and the fifth coordinate data generation device 902. Besides, the angle detection unit 1106 calculates the relative angle θ between the feature point positioning unit 904 and the fifth coordinate data generation device 902 according to the rotation angle of the laser emitting unit 1102. After that, the wireless transmission unit 1108 of the feature point positioning unit 904 transmits the relative distance L and the relative angle θ to the wireless transmission unit 1014 of the fifth coordinate data generation device 902. Finally, the controller 1004 calculates the displacements of the fifth coordinate data generation device 902 relative to the reference point R on the axis X and the axis Y according to the relative distance L and the relative angle θ captured by the physical information capturing unit 1002, so as to generate the map coordinate data corresponding to the position (i.e., the real position A) of the fifth coordinate data generation device 902.

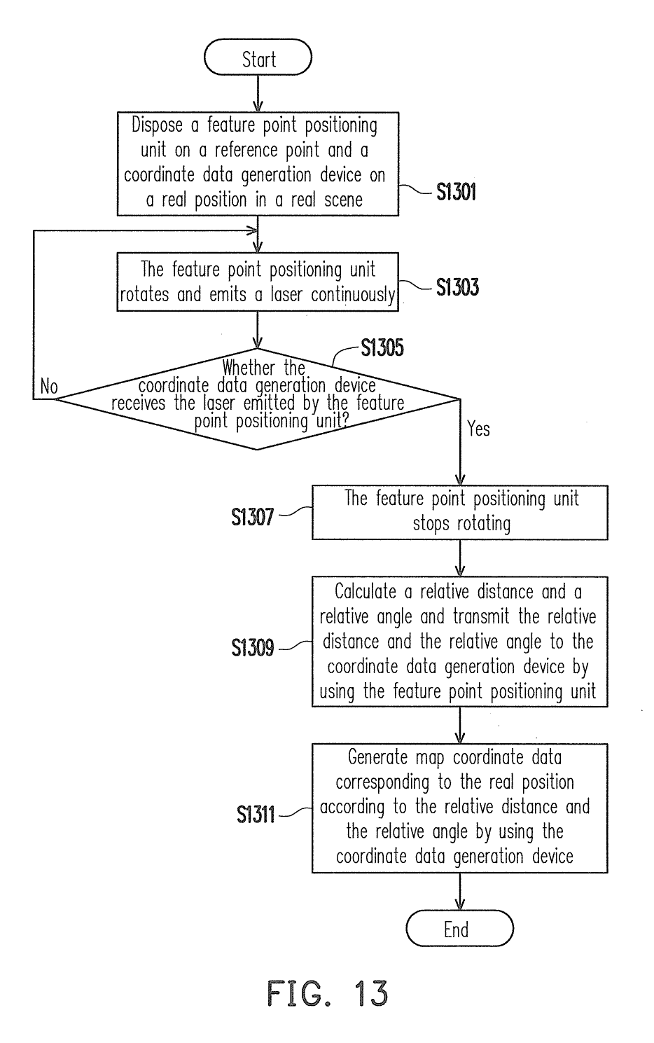

FIG. 13 is a flowchart of a coordinate data generation method according to the second exemplary embodiment of the disclosure.

Referring to FIG. 13, first, in step S1301, the feature point positioning unit 904 is disposed on the reference point R in the real scene, and the fifth coordinate data generation device 902 is disposed on a real position (for example, the real position A).

Then, in step S1303, the feature point positioning unit 904 rotates and emits a laser continuously. Next, in step S1305, whether the fifth coordinate data generation device 902 receives the laser emitted by the feature point positioning unit 904 is determined.

If the fifth coordinate data generation device 902 does not receive the laser, the feature point positioning unit 904 continues to rotate and emit laser (i.e., step S1303). If the fifth coordinate data generation device 902 receives the laser, in step S1307, the feature point positioning unit 904 stops rotating. As described above, when the fifth coordinate data generation device 902 receives the laser, the fifth coordinate data generation device 902 transmits an acknowledgement message to the feature point positioning unit 904, and the feature point positioning unit 904 stops rotating according to the acknowledgement message.

After that, in step S1309, the feature point positioning unit 904 calculates the relative distance and the relative angle and transmits the relative distance and the relative angle to the fifth coordinate data generation device 902.

Finally, in step S1311, the fifth coordinate data generation device 902 generates the map coordinate data corresponding to the real position according to the relative distance and the relative angle.

In the present exemplary embodiment, when the map coordinate data corresponding to the real positions B, C, and D is to be generated, a user simply moves the fifth coordinate data generation device 902 to the real positions B, C, and D and the fifth coordinate data generation device 902 then automatically generates the map coordinate data corresponding to the real positions B, C, and D.

Similar to the first exemplary embodiment, after the camera 102 captures the image plane of the real scene, the coordinate data recognition device 112 analyzes and recognizes the light source emitted by the fifth coordinate data generation device 902 and calculates the image coordinate data corresponding to the image positions A′, B′, C′, and D′, decodes the light source emitted by the fifth coordinate data generation device 902 to receive the map coordinate data corresponding to the real positions A, B, C, and D, and calculates the coordinate transform matrix corresponding to the camera 102 according to the image coordinate data corresponding to the image positions A′, B′, C′, and D′ and the map coordinate data corresponding to the real positions A, B, C, and D.

As described above, in exemplary embodiments of the disclosure, a coordinate data generation device can automatically generate the map coordinate data corresponding to the position of the coordinate data generation device and transmit the map coordinate data through a light source. In addition, in exemplary embodiments of the disclosure, a coordinate data recognition device can recognize an image position corresponding to a coordinate data generation device in an image plane captured by a camera and calculate the image coordinate data corresponding to the image position. Moreover, in exemplary embodiments of the disclosure, a coordinate data recognition device can obtain the map coordinate data generated by a coordinate data generation device according to a light source emitted by the coordinate data generation device. Thereby, in exemplary embodiments of the disclosure, a coordinate transform matrix corresponding to a camera can be automatically generated according to the image coordinate data and the map coordinate data, so as to calibrate the camera.

It will be apparent to those skilled in the art that various modifications and variations can be made to the structure of the disclosure without departing from the scope or spirit of the invention. In view of the foregoing, it is intended that the disclosure cover modifications and variations of this invention provided they fall within the scope of the following claims and their equivalents.

What is claimed is:

1. A camera calibration system, comprising:
at least one coordinate data generation device, disposed in a real scene, for generating a plurality of map coordinate data respectively corresponding to a plurality of different real positions on a ground plane of the real scene according to a map coordinate system; and
a coordinate data recognition device, electrically connected to a camera, for receiving an image plane of the real scene from the camera and receiving the map coordinate data from the coordinate data generation device,
wherein the coordinate data recognition device recognizes an image position corresponding to each of the real positions on the image plane and calculates an image coordinate data corresponding to each of the image positions according to an image coordinate system of the image plane,
wherein the coordinate data recognition device calculates a coordinate transform matrix corresponding to the camera according to the image coordinate data and the map coordinate data.

2. The camera calibration system according to claim 1, wherein the coordinate data generation device comprises:
a physical information capturing unit, for capturing physical information between a reference point and the real positions in the real scene;
a controller, electrically connected to the physical information capturing unit, for generating and encoding the map coordinate data according to the physical information between the reference point and the real positions in the real scene; and
a light emitting unit, electrically connected to the controller, for generating a
light source and transmitting the encoded map coordinate data.

3. The camera calibration system according to claim 2, wherein the coordinate data recognition device comprises:
a light source positioning unit, for recognizing the light source generated by the light emitting unit to obtain the image coordinate data;
a light emitting signal decoding unit, electrically connected to the light source positioning unit, for decoding the encoded map coordinate data according to the light source generated by the light emitting unit; and
a coordinate transform calculation unit, electrically connected to the light source positioning unit and the light emitting signal decoding unit, for calculating the coordinate transform matrix corresponding to the camera according to the image coordinate data and the map coordinate data.

4. The camera calibration system according to claim 2, wherein the physical information capturing unit comprises an accelerometer for measuring accelerations of moving from the reference point to the real positions in the real scene,
wherein the controller calculates displacements of the real positions according to the accelerations of moving from the reference point to the real positions in the real scene measured by the accelerometer and generates the map coordinate data corresponding to the real positions according to the displacements of the real positions.

5. The camera calibration system according to claim 2 further comprising a feature point positioning unit disposed on the reference point,
wherein the feature point positioning unit emits a laser, measures relative distances and relative angles of the real positions through the laser, and transmits the relative distances and the relative angles of the real positions.

6. The camera calibration system according to claim 5, wherein the physical information capturing unit receives the laser and the relative distances and the relative angles of the real positions from the feature point positioning unit,
wherein the controller calculates the map coordinate data respectively according to the relative distances and the relative angles of the real positions.

7. The camera calibration system according to claim 5, wherein the feature point positioning unit comprises:
a laser emitting unit, for rotating and emitting the laser;
a distance detection unit, for detecting an emitted distance of the laser to measure the relative distances of the real positions;
an angle detection unit, for detecting an emitted angle of the laser to measure the relative angles of the real positions; and
a wireless transmission unit, for transmitting the relative distances and the relative angles of the real positions.

8. The camera calibration system according to claim 6, wherein the physical information capturing unit comprises:
a laser receiving unit, for receiving the layer; and
a wireless transmission unit, for receiving the relative distances and the relative angles of the real positions.

9. The camera calibration system according to claim 1, wherein the coordinate transform matrix is a homograph matrix.

10. The camera calibration system according to claim 1, wherein the map coordinate system is a longitude/latitude coordinate system or a 2-degree transverse Mercator (TM2) coordinate system.

11. A camera calibration method, comprising:
disposing at least one coordinate data generation device in a real scene;
obtaining an image plane corresponding to the real scene by using a camera;
automatically generating a plurality of map coordinate data corresponding to a plurality of different real positions on a ground plane of the real scene according to a map coordinate system by using the at least one coordinate data generation device;
transmitting the map coordinate data corresponding to the real positions by using the at least one coordinate data generation device;
recognizing an image position corresponding to each of the real positions in the image plane;
calculating an image coordinate data corresponding to each of the image positions according to an image coordinate system of the image plane;
receiving the map coordinate data corresponding to the real positions; and
calculating a coordinate transform matrix corresponding to the camera according to the image coordinate data and the map coordinate data.

12. The camera calibration method according to claim 11, wherein the step of transmitting the map coordinate data corresponding to the real positions by using the at least one coordinate data generation device comprises:
encoding the map coordinate data; and
transmitting the encoded map coordinate data by using at least one light source emitted by the at least one coordinate data generation device.

13. The camera calibration method according to claim 12, wherein the step of receiving the map coordinate data corresponding to the real positions comprises:
receiving the at least one light source emitted by the at least one coordinate data generation device and decoding the encoded map coordinate data.

14. The camera calibration method according to claim 12, wherein the step of recognizing the image position corresponding to each of the real positions in the image plane comprises:
recognizing the image position corresponding to each of the real positions in the image plane according to the at least one light source emitted by the at least one coordinate data generation device.

15. The camera calibration method according to claim 11, wherein the step of automatically generating the map coordinate data corresponding to the real positions on the ground plane of the real scene according to the map coordinate system by using the at least one coordinate data generation device comprises:
measuring accelerations of moving from a reference point to the real positions in the real scene by using the at least one coordinate data generation device;
calculating displacements of the real positions to the reference point in the real scene according to the accelerations; and
generating the map coordinate data corresponding to the real positions according to the displacements of the real positions to the reference point in the real scene.

16. The camera calibration method according to claim 11, wherein the step of automatically generating the map coordinate data corresponding to the real positions on the ground plane of the real scene according to the map coordinate system by using the at least one coordinate data generation device comprises:
disposing a feature point positioning unit on a reference point in the real scene to emit a light source;
detecting relative distances and relative angles between the real positions and the reference point through the light source by using the feature point positioning unit; and
calculating the map coordinate data according to the relative distances and the relative angles between the real positions and the reference point.

17. The camera calibration method according to claim 11, wherein the coordinate transform matrix is a homograph matrix.

18. The camera calibration method according to claim 11, wherein the map coordinate system is a longitude/latitude coordinate system or a TM2 coordinate system.

19. A coordinate data generation system, comprising:
a physical information capturing unit, for capturing physical information between a reference point in a real scene and a real position in the real scene; and
a controller, electrically connected to the physical information capturing unit, for generating a map coordinate data corresponding to the real position in a map coordinate system according to the physical information between the reference point and the real position.

20. The coordinate data generation system according to claim 19 further comprising:
a light emitting unit, electrically connected to the controller, for generating a light source,
wherein the controller encodes the map coordinate data, and the light emitting unit transmits the encoded map coordinate data through the light source.

21. The coordinate data generation system according to claim 19, wherein the physical information capturing unit comprises an accelerometer for measuring an acceleration of moving from the reference point to the real position in the real scene,
wherein the controller calculates a displacement of the real position according to the acceleration of moving from the reference point to the real position in the real scene measured by the accelerometer and generates the map coordinate data corresponding to the real position according to the displacement of the real position.

22. The coordinate data generation system according to claim 19 further comprising a feature point positioning unit disposed on the reference point,
wherein the feature point positioning unit emits a laser, measures a relative distance and a relative angle of the real position through the laser, and transmits the relative distance and the relative angle of the real position.

23. The coordinate data generation system according to claim 22, wherein the physical information capturing unit receives the laser and the relative distance and the relative angle of the real position from the feature point positioning unit,
wherein the controller calculates the map coordinate data corresponding to the real position according to the relative distance and the relative angle of the real position.

24. The coordinate data generation system according to claim 22, wherein the feature point positioning unit comprises:
a laser emitting unit, for rotating and emitting the laser;
a distance detection unit, for detecting an emitted distance of the laser so as to measure the relative distance of the real position;
an angle detection unit, for detecting an emitted angle of the laser so as to measure the relative angle of the real position; and
a wireless transmission unit, for transmitting the relative distance and the relative angle of the real position.

25. The coordinate data generation system according to claim 23, wherein the physical information capturing unit comprises:
a laser receiving unit, for receiving the laser; and
a wireless transmission unit, for receiving the relative distance and the relative angle of the real position.

26. The coordinate data generation system according to claim 19, wherein the map coordinate system is a longitude/latitude coordinate system or a TM2 coordinate system.

27. A coordinate data generation method, comprising:
disposing a coordinate data generation device in a real scene; and
automatically capturing physical information between a reference point in the real scene and a real position in the real scene and generating a map coordinate data corresponding to the real position in a map coordinate system according to the physical information by using the coordinate data generation device.

28. The coordinate data generation method according to claim 27 further comprising:
encoding the map coordinate data; and
generating a light source and transmitting the encoded map coordinate data through the light source by using the coordinate data generation device.

29. The coordinate data generation method according to claim 27, wherein the step of automatically capturing the physical information between the reference point in the real scene and the real position in the real scene and generating the map coordinate data corresponding to the real position in the map coordinate system according to the physical information by using the coordinate data generation device comprises:
measuring an acceleration of moving from the reference point to the real position in the real scene;
calculating a displacement of the real position according to the acceleration; and
generating the map coordinate data corresponding to the real position according to the displacement of the real position.

30. The coordinate data generation method according to claim 27, wherein the step of automatically capturing the physical information between the reference point in the real scene and the real position in the real scene and generating the map coordinate data corresponding to the real position in the map coordinate system according to the physical information by using the coordinate data generation device comprises:
disposing a feature point positioning unit on the reference point to emit a light source;
detecting a relative distance and a relative angle between the real positions and the reference point through the light source by using the feature point positioning unit; and
calculating the map coordinate data corresponding to the real position according to the relative distance and the relative angle between the real position and the reference point.

31. The coordinate data generation method according to claim 27, wherein the map coordinate system is a longitude/latitude coordinate system or a TM2 coordinate system.
